(19) United States
(12) Patent Application Publication
(10) Pub. No.: US 2006/0283805 A1
(43) Pub. Date: Dec. 21, 2006

(54) Advanced separator system

(76) Inventor: Rudy Schreppel JR., Broken Arrow, OK (US)

Correspondence Address: RUDY SCHREPPEL, JR., 525 S. LAUREL AVE., BROKEN ARROW, OK, 74012, US

(21) Appl. No.: 11/156,644

(22) Filed: Jun. 21, 2005

(51) Int. Cl. C02F 1/52

(52) U.S. Cl. 210/721

(57) ABSTRACT

A method for the remediation of contaminated liquid stream wherein liquid is passed through a reactor loop before entering tank and reactor loop is a series of conduits with internal baffles with openings wherein reactor loop causes ionization in the liquid stream before entering tank wherein liquids are additionally passed through aeration chambers within the tank with aeration chamber outlet causing a tangential clockwise flow in liquids causing heavy contaminates to fall to the bottom and be removed via a cone trap outlet and lighter contaminates to be skimmed off liquid surface by a centrally disposed cone trap for removal wherein liquids within the tank are separated from contaminates and discharged as cleans effluent.

### BACKGROUND OF THE INVENTION

This application claims priority from provisional application No. 60/578,295 filed on 06/10/2004. The invention relates to products used to separate solids and other pollutants from water that may come from a lake, pond or other water sources. The invention may be used to produce drinking water or may be used for the remediation of wastewater. The advanced separator system is typically used with liquids operating at low to moderate ambient temperatures and pressures.

There are many means for removing organic or inorganic contaminants and other inclusions from contaminated liquids. These methods may include filtration, stripping, absorption, and ion exchange. In the case of organic contaminants, the ultimate end products of the invention are typically nontoxic substances such as water and carbon dioxide.

The invention may be used within wastewater streams from industrial process plants including but not limited to coal cleaning within the coal industry, purification units within the inorganic chemical industry, or as a stripper or reactor within the organic chemical industry. This invention may also be used in bottling plants, cooling towers, green houses, hospitals, processing plants, and any number of commercial municipalities or waste water treatment facilities.

The invention has many uses within a variety of industries, including wastewater treatment, waste gas treatment, the plastics industry, wood and paper processing and even the hazardous waste industry. Any industry that needs to separate waste or pollutants from wastewater will be able to utilize this invention.

The invention utilizes a cylindrical tank with a tapered or cone bottom to facilitate and trap for removal the particulate material that is the contaminate. The tank may be either of a metal or plastic construction. Tanks may typically have splash guard on top and steel or plastic skirts surrounding the bottom or cone area with access for piping. A manhole entry may also be available at the top.

The water or liquid to be treated enters through a clockwise tangential-entry inlet port at the top of the tank. The liquid is drawn into a bottom aeration column by the action of the aerators creating suction. The liquid then exits back into the tank through tangential exits located at the top of the tank. This creates and maintains a clockwise flow rotation that optimizes the separation of the particulate matter by forcing it to the sides of the tank and then downward to the center of the cone area.

Additionally, this invention further advances the technology of separation by including a reactor loop and oxidation means to the wastewater or liquid stream entering the tank. Said reactor loop comprising a series of conduits affixed with u-shaped connectors and having internal baffles designed to create ionization of the liquid stream.

When the liquid stream is put under pressure within the inlet stream within the invention, the metal construction within the reactor loop conduits give up electrons which combine with the liquid molecules and with the particle molecules causing the similarly charged liquid and particles to repel and separate from each other. This treatment of the wastewater or liquid stream offers a new and novel way to improve the separation of the particulate matter within the liquids.

### BRIEF SUMMARY OF THE INVENTION

The present invention utilizes a combination of methods to separate solids and pollutants within a wastewater or liquid stream. The methods include ion exchange, aeration, centrifugal flow, and oxidation reaction as well as gravity and flow. The wastewater flow is first passed through a cylinder like conduit that contains a multiplicity of spaced baffles positioned at an angle to be determined per application.

Said baffles lining the longitudinally extended walls from entrance to exit end of the cylinder with said baffles each having a series of opening. The liquid is pumped under pressure into the conduit causing a multiplicity of streams or jets to issue from the baffle opening causing fluids to bombard the inner surface conduit wall and the other baffles within the conduit. The entry end of the cylinder may have a filter screen into the conduit when needed.

Conduit and baffles may be made of copper, nickel, or other like metals for the purpose of assisting in the production of creating an ion exchange reaction within the conduit. Conduit may be made of a copper-nickel alloy or, preferably, the outer pipe is made of a ferrous metal and the inner surface or lining of the outer pipe may be flame coated with a copper-nickel alloy.

The reactor is important to accomplish efficient remediation of wastewater. This invention furthermore incorporates within its design the use of mechanical pressure, cavitation, and catalyst processes to induce a negative charge in the medium and to force dissimilar bonds to separate.

The combination of simultaneous reactions utilized within this system affect the molecular structure and the positive and negative charge of the liquid medium in a method that produces greater oxidation efficiencies and enhanced molecular homogeneity. The process utilizes advanced technology that affects the molecular structure of contaminated liquid by influencing the molecular charge of the organic substance that can be either liquid or suspended solids.

Upon passing through the reactor loop the wastewater enters the tank through a clockwise tangential-entry inlet port at the top of the tank. The liquid is drawn into the bottom aeration columns by the action of the aerators creating suction. The liquids then exit back into the tank through tangential exits located at the top of the tank. This creates and maintains a clockwise flow rotation that optimizes the separation of the particulate matter by forcing it to the sides of the tank and then downward to the cone area.

The centrifugal flow of the influent material is dispersed outwardly in the tank and the heavy contaminates fall to the bottom. The lighter material will float and accumulate or otherwise form on the top of the liquid and is forced to fill the surface area of the liquid in the tank. When this happens the lighter floating contaminates is forced into a centrally disposed cone or cylinder with a central opening in the top designed for collecting the lighter materials. Said opening being in direct communication with an opening or conduit at bottom of cone to allow for discharge to an outlet line. Said line may also be connected to heavy contaminant line for removal of contaminates.

A skimming process also takes place allowing oil and grease products to be removed. The skimmer blade is pivotally attached to the skimmer arm and includes resilient, flexible wiper blades that provide a substantially tight seam as it provides a trough leading to the receiving chamber. Heavier contaminants are removed from the bottom of the vessel.

The wastewater is additionally being processed and forced to flow in a clockwise motion during this action of separation. Clockwise motion is forced by the liquids entering the aeration columns powered by the airlift pumping action of air being forced into said columns at a clockwise motion. All aeration columns shall have tangential inlets and outlets to force liquid flow.

The centrifugal flow along with the aeration events further cause the chemical oxidation or reduction of organic and inorganic contaminants, including the cellular components of destroyed microorganisms or larvae.

The invention offers new and unique processes offering improved cost and time efficient methods for high volume remediation processing that will revolutionize the environmental industry. The invention can speed up the remediation process and save thousands of dollars per site.

The foregoing and other objectives, features, and advantages of the invention will be more readily understood upon the consideration of the following detailed description of the invention.

### BRIEF DESCRIPTION OF THE DRAWINGS

FIG. 1 is a cross sectional view of the invention.

FIG. 2 is a top view with the invention.

FIG. 3 is a cross section of the reactor conduit.

### DETAILED DESCRIPTION OF THE DRAWINGS

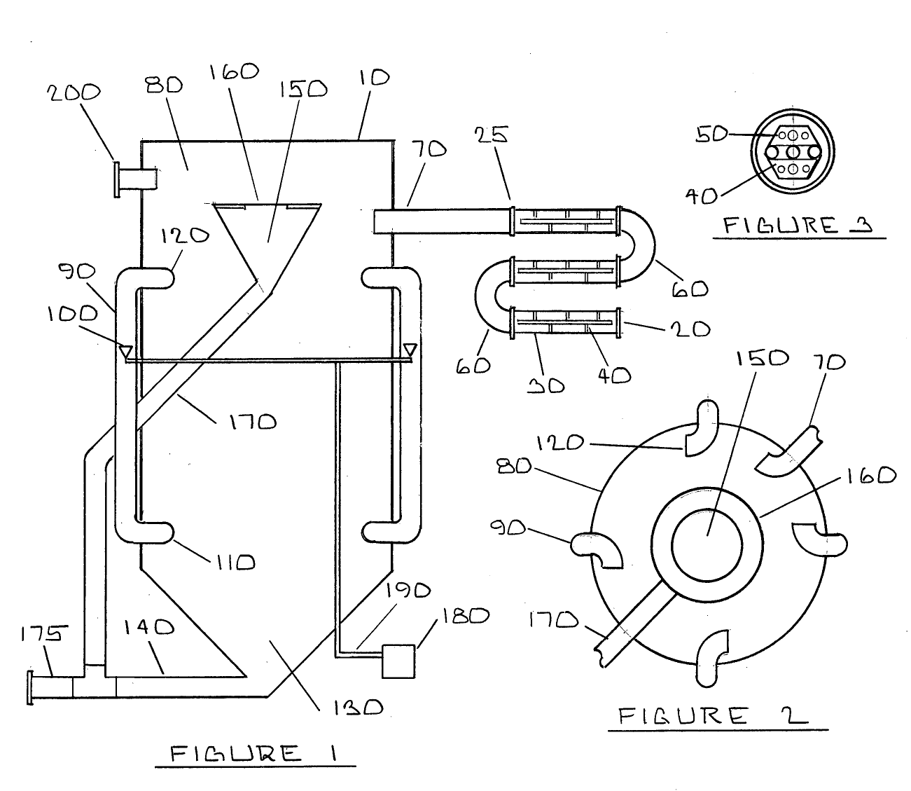

FIG. 1 shows the Advanced Separator System 10 and is schematically described herein. An influent stream of wastewater containing contaminants is removed from the industrial process and introduced into inlet 20 where liquid is pumped into a conduit 30 comprising a concentric elongated cylindrical metal conduit. Each conduit may be made of copper-nickel alloy or, made of a ferrous metal with the inner surface or lining of the outer pipe flame coated with a copper-nickel alloy.

Wastewater shall be pumped into inlet 20 at a pressure or such force to produce strong turbulence. Any number of commercially available pumps (Not Shown) may be used to supply liquids to the inlet 20. Upon entering conduit 30 the fluids pass over, around, and through the baffles 40 shown in FIG. 1 and in more detail in FIG. 3. Baffles 40 shall cause a multiplicity of turbulence thereby creating ionization of the liquid stream. Liquid stream shall be under such pressure to cause fluids to give up and exchange electrons thus creating a reactor chamber within the conduit 30.

Conduit 30 shall contain a multiplicity of spaced baffles 40 furthermore containing radially bored openings 50 as indicated in FIG. 3 located throughout the proximity of the baffle surface area. The entry end of conduit 30 is joined to a flange 25 for connection or engagement to a pump (Not Shown) and the exit end of conduit 30 being affixed with a similar or like flange 25.

Exit end flange 25 shall be attached to a circular shaped elongated cylindrical metal pipes or like conduit 60 having a u shaped configuration with a flange 25 attached on each end. Wherein flange 25 facilitates an attachment means for the purpose of attaching a series of conduit 30 and circular shaped conduits 60 in series to the degree required by the process.

The liquids after being treated in conduit 30 are then passed through circular or U-shaped conduit 60 that may also act as a deceleration or turbulence means. The function of the deceleration is to create an abrupt decrease in the momentum of the stream exiting from conduit 30. Said action increasing turbulence and energy within the fluids. Said u shaped connectors 60 allowing for an imbricate configuration within the series of conduits 30.

Circular shaped conduit 60 furthermore allowing for stacked configuration of a series of the conduits 30 which may be adjustable in height and width based upon the angle in which the u shaped conduits are affixed or otherwise connected.

For best results the sum of the cross-sectional areas of the multiplicity of baffles 40 should equal or, preferably, be greater than the cross-sectional area of inner conduit 30 in order to prevent any back pressure or flow restriction during operation. Moreover, the jet velocity, that is, the velocity of the liquid jets as it exits from the outlet flange 25 should be at least 0.025 feet (0.0076 m) per second. One formula for computing the jet velocity in feet (m) per second of the liquid or gas existing from outlet 25 is 4,085 times the gallons (3.785 liters) per minute divided by the square of the diameter of openings in the flange outlet 50.

Upon passing through the reactor loop comprising conduits.30 and unshaped connectors 60 the wastewater enters the tank through a tangential entry inlet port 70 at the top of the tank. Wherein the liquid upon filling the tank 80 is drawn into the bottom of the aeration columns 90 by the action of the aerators 100 creating suction thus forcing liquids to enter inlets 110.

The number of inlets 110 and aeration columns 90 shall be determined by the size and requirements of the tank 80. The liquids then exits back into the tank through tangential exit conduits 120 located at the top of the tank. The exit conduits 120 aimed within the tank 80 to create and maintains a clockwise flow rotation that optimizes the separation of the particulate matter by forcing it to the sides of the tank and then downward to the cone area 130.

Aeration columns 90 shall have aerators 100 in each column that are fed by an air pump 180. The air pump 180 feeding air to all used aerator columns 90 through air lines 190. Said aerators 100 creating additional aeration, oxidization, and flow to liquids within the aeration columns 90 and the tank 80.

The centrifugal flow of the influent material is dispersed outwardly in the tank and the heavy contaminates fall to the bottom of cone 130 where they are removed through outlet 140. A valve (Not Shown) may be utilized on outlet line. The lighter material will float and accumulate or otherwise form on the top of the liquid and is forced to fill the surface area of the liquid in the tank 80. The lighter floating contaminates are forced into a centrally disposed cone 150 with a central opening 160 in the top.

Said opening 160 designed for skimming and collecting the lighter materials floating in tank 80. Cone 150 being placed to proper height according to outlet 200 height. Said cone opening 160 having a conduit 170 at the bottom of the cone for the removal of contaminates. Conduit 170 being a discharge to outlet line 175 that may also be connected to other outlet lines such as line 140 for removal of contaminates. A valve (Not Shown) may be utilized on outlet line 170.

The present invention is well suited for operation in a continuous decontamination and filtering systems. Systems may includes feed reservoir for receiving the flow of contaminated liquid through feed pipe as well as optionally receiving untreated liquid from recycle or primary pumps.

Sampling ports may also be utilized to permits testing of the treated fluid. Adjustment of the flow may be adjusted by any suitable outside means and may be used to determine residence time of the fluid in tank 80. Upon the liquids being cleaned of contaminates they are removed via outlet 200. Outlet 200 may consist of any opening or chamber located at the proper height to suitably remove the clean effluent liquid.

Terms and expressions that have been employed in the forgoing specifications are used therein as terms of description and not of limitation, and there is no intention in the use of such terms and expressions of excluding equivalents of the features shown and described in portions thereof.

What is claimed is:

1. A method for the remediation of contaminated liquid utilizing an advanced separator system incorporating a reactor loop at the inlet comprising a series of conduits with internal baffles with openings wherein said reactor loop causes ionization in the liquid stream before entering tank wherein liquids are passed through aeration chambers with outlets causing a tangential clockwise flow causing heavy contaminates to fall and be removed via a lower cone trap and lighter contaminates to be skimmed off liquid surface by a centrally disposed upper cone trap wherein liquids are separated from contaminates and discharged as cleans effluent.

2. The method of claim 1 wherein means are included to inject metered amounts of chemicals into fluids.

3. The method of claim 1 wherein skimmer blades are utilized for floating debris.

4. The method of claim 1 wherein tank is heated to assist process.

5. The method of claim 1 wherein liquid is heated prior to introduction into tank.

6. The method of claim 1 wherein oxidizing agents are fed into tank or stream.

7. The method of claim 1, wherein a feed pump has an impeller produced of materials also promoting ion exchange.

8. The method of claim 1, wherein u-shaped connectors within reactor loop have internal veins to increase turbulence within the reactor loop.

9. The method of claim 1, wherein a helix of copper or copper-nickel alloy wire is wrapped within the inner conduit of the u-shaped connector utilized within reactor loop.

10. The method of claim 1, wherein baffles are angled within the inner wall of the reactor conduit.

11. The method of claim 1, wherein the baffles opening are of different sizes upon the different baffles.

12. The method of claim 1, wherein the flanges on the reactor loop conduits are replaced with welded connections.

13. The method of claim 1, wherein baffles within the conduit are sized differently.

14. The method of claim 1, wherein a first elongated metal pipe having an entry end and an exit end shall not have baffles.

15. The method of claim 1, wherein the baffles are placed within conduit to create a spinning flow of the fluids.

16. The method of claim 1, wherein the baffles are attached to a rod not attached to conduit.

17. The method of claim 1, wherein the baffles are attached to a centrally disposed plate not attached to conduit.

18. The method of claim 1, wherein the baffle is a centrally disposed plate inserted within conduit wherein plate has cutout tangs bent up to create desired effect.
